(19) United States
(12) Patent Application Publication
(10) Pub. No.: US 2025/0225792 A1
(43) Pub. Date: Jul. 10, 2025

(54) SnapGuardian Cam - An Innovative and Expanded Cloud-Powered AI System for Image Analysis and Device Control in Security, Environmental Monitoring and Multipurpose Use

(71) Applicant: Fernando Nunes Buarque, White Bear Lake, MN (US)

(72) Inventor: Fernando Nunes Buarque, White Bear Lake, MN (US)

(21) Appl. No.: 18/406,119

(22) Filed: Jan. 6, 2024

(51) Int. Cl. G06V 20/52; G08B 21/00; H04W 4/14

(52) U.S. Cl. CPC G06V 20/52; G08B 21/00; H04W 4/14

(57) ABSTRACT

This invention discloses a novel and autonomous system, provisionally named as SnapGuardian Cam, that leverages cloud-based AI for image analysis and device control. Utilizing a camera and mini-CPU, SnapGuardian captures images in a stand-alone mode and sends them, along with natural language prompts and instructions, to AI cloud platforms, like Google Cloud AI for instance, through a network (cable, wireless or mobile network). Upon receiving analysis results, the system can trigger external devices through relay outputs, send alerts via various channels, file the pictures, performing counts, generating reports, and communicate responses back to the user. This unique combination of simplicity, cloud-powered intelligence, and natural language parametrization and configuration unlocks a vast array of potential applications for security, environmental monitoring, scientific research, personal use, safety, industrial application, business management, and unlimited uses in all areas. The system can be easily parametrized and configured through the existing man-machine interface on the device itself (for models equipped with this feature) or through a mobile app connected via Bluetooth, cable, or remotely. In the latter case, configuration can be done not only through the mobile app but also through a computer application. Despite of it was especially designed for stand-alone use, it can be integrated into an internal TV circuit system or a remote administration system for a network of cameras that can centrally manage the configuration of each camera and receive alerts and reports.

### FIELD OF INVENTION

The present invention pertains to the field of autonomous systems integrating cloud-based artificial intelligence (AI) for comprehensive image analysis and device control. Specifically, the invention introduces the SnapGuardian Cam, a unique system employing a camera and mini-CPU. This innovative system operates independently, capturing images and transmitting them, accompanied by natural language prompts, to the Google Cloud AI platform via various network modalities (cable, wireless, or mobile network). The subsequent analysis results empower the system to activate external devices through relay outputs, issue alerts across diverse communication channels, and provide responsive communication to the user. The inventive integration of simplicity, cloud-based intelligence, and natural language programming opens up diverse applications in the realms of security, environmental monitoring, safety, scientific research, personal use, residential use and various industrial and commercial sectors. Notably, the system offers programmability through a dedicated app, accessible via mobile or computer devices, utilizing Bluetooth, Wi-Fi, or cable connections, and also enables remote programming through network connections, whether via mobile networks or local Wi-Fi.

### BACKGROUND

The development of SnapGuardian Cam responds to the increasing demand for autonomous systems seamlessly integrating cloud-based artificial intelligence (AI) to revolutionize image analysis and device control. The invention introduces a groundbreaking solution-a plug-and-play, stand-alone unit designed to capitalize on the existing capabilities of Cloud AI, such as various Cloud AI platforms available, and future advancements in these systems.

The primary motivation behind this invention is to democratize intelligent image analysis, eliminating the need for intricate hardware setups or specialized training. The product leverages simplicity by combining a camera and mini-CPU to function autonomously. Captured images are transmitted, along with natural language prompts, to cloud-based AI platforms through various network modalities, including cable, wireless, or mobile networks.

The system's versatility and ease of integration unlock a myriad of potential applications across diverse sectors. Innovative features include the activation of external devices through relay outputs, issuing alerts across various communication channels, and providing responsive communication to the user. This integration of simplicity, cloud-based intelligence, and natural language programming addresses critical needs in security, environmental monitoring, safety, scientific research, business, residential use, and unlimited industrial, commercial, scientific, and personal areas.

To further exemplify the system's unlimited applications, consider the alarming statistics of over 350 deaths per year in the US, involving small children falling into pools when there is no adult nearby. Beyond physical protection measures, the system can monitor such situations and similar ones, like unaccompanied animals falling into pools and drowning from exhaustion.

Moreover, the intelligent processing capabilities of the system significantly reduce the number of false or lack of alarms (false positive or negatives), a notable improvement over traditional presence sensors like passive infrared sensors and other. This feature ensures practicality in various applications, preventing potential challenges associated with false alarms.

As the system is configured and parameterized through natural language, its popularity is likely to increase, expanding the number of possible applications. This innovative approach to intelligent image analysis positions SnapGuardian Cam as a versatile and user-friendly solution with broad applicability across different sectors and scenarios, irrespective of the specific Cloud AI platform being utilized.

Some additional examples of possible system use, but by no means exhaustive:
The system sends aerial photos at intervals from a parking lot and simultaneously sends the prompt asking: “In the parking lot shown, are there fewer than 10 unoccupied spaces? Answer Yes or No.” Based on the response, the administrator can consider the parking lot full or not. Alternatively, it can simply inquire about the number of available spaces.
The system sends photos triggered by a passive infrared sensor built into the camera and asks if there is a groundhog in the photo. This creates a filter to exclude photos of any other animal.
The system sends photos at predetermined intervals from a school area and asks if there is anyone carrying a weapon in the photo who is not a uniformed police officer.
The system sends photos of a highway where truck traffic is prohibited, triggered by an in-ground inductive sensor, and asks if there is a truck in the photo.
The system sends photos at intervals from an outdoor area of a fuel products plant and asks if anyone is smoking in the photo.

Based on the various situations exemplified above, the system can perform counts, generate event reports, store images of interest in the cloud, send remote alerts, trigger alarms, and/or turn devices on or off, for example.

### BRIEF SUMMARY OF THE INVENTION

The present invention introduces an innovative camera system provisionally denoted as SnapGuardian Cam. This autonomous system seamlessly integrates cloud-based artificial intelligence (AI) for exhaustive image analysis and device control. The core components of the system include a camera and a mini-CPU, when the camera doesn't have an integrated CPU, collectively forming an independent unit. The camera captures images at specified intervals, in response to predefined events or trigged by a sensor. The mini-CPU, responsible for image management, operates the system's timing, intervals, outputs, and supplementary sensors to trigger events.

The captured images are transmitted along with natural language prompts to the Google Cloud AI platform, or to another clouded AI, through versatile network modalities such as cable, wireless, or mobile networks. Upon reception, the cloud server undertakes a comprehensive AI-based analysis of the images, interpreting them based on concurrent instructions received from the mini-CPU, which was parametrized in natural language, as question about the sent image for instance. Subsequently, depending on the response received from the AI, the system is empowered to execute commands, triggering external devices through relay outputs, issuing alerts through various communication channels, and engaging in responsive communication with the user.

The SnapGuard Cam can be easily configured through the existing man-machine interface on the device itself (for models equipped with this feature) or through a mobile app connected via Bluetooth, cable, or remotely. In the latter case, configuration can be done not only through the mobile app but also through a computer application.

Despite being especially useful for stand-alone use, the SnapGuard Cam can be integrated into an internal TV circuit system or a remote administration system for a network of cameras that can centrally manage the configuration of each camera and receive alerts.

SnapGuardian is a novel and innovative system that has the potential to revolutionize the way we interact with the world around us. The system's combination of simplicity, cloud-powered intelligence, and natural language programming unlocks a vast array of potential residential or non-residential applications, such as safety, security, environmental monitoring, scientific research, industrial automation, accessibility, recreation, educational, and many other applications.

### BRIEF DESCRIPTION OF THE DRAWINGS

FIG. 1 illustrates one possible and basic functional and communication cycle of the system; however, it is not an exhaustive configuration, as there is always the possibility of adding accessories or intermediate communication and control stages, such as the many that have been detailed and exemplified throughout this patent specification.

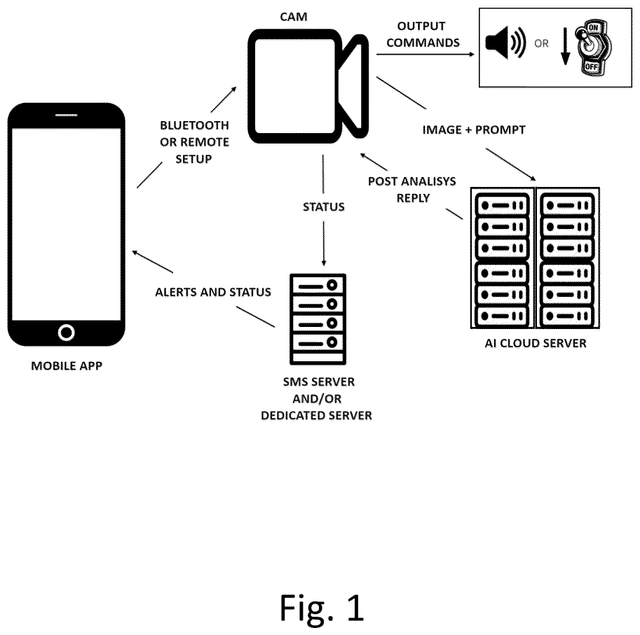

FIG. 2 demonstrates the system's usage potential and the tremendous simplicity of parameterization, even for a user without specific technical qualifications. In the figure, there is a field labeled REQUEST [001] where the user can describe an instruction or question to be forwarded along with the image to the AI. Three fields with predefined functionality are also shown, meant to be simply marked. The first field [002] predetermines the format of the AI's response. In this case, an additional prompt will be generated and added to the previous one. In the second field [003], the user determines whether an alarm should be triggered if the response is YES. In the third field [004], the user determines whether a message should be forwarded to the number and in the format to be filled in the subsequent fields [005 and 006]. Obviously, this is a limited example of the many parameters that may be available to the user.

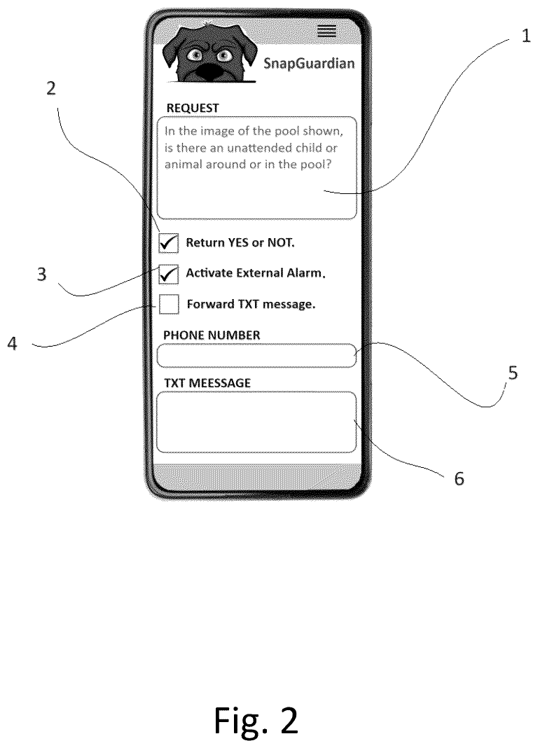

### DETAILED DESCRIPTION OF THE INVENTION

A camera: The camera captures images of the environment. The images can be captured at regular intervals, in response to specific events or trigged by sensors. The camera can be even a low-cost model or a more complex one.

A mini-CPU: The mini-CPU manage the images captured by the camera. The mini-CPU is responsible for controlling times and intervals, using supplementary sensors to trigger events, manage the external communications, preprocess the image if necessary, save the images, and send them to the AI external server along with the prompt, receive the answer of the server and manage the subsequent actions, control external device and send information and alerts for other devices like mobiles and computers.

AI cloud server: The cloud server analyzes the images sent by the mini-CPU. The server uses AI to understand the images accordingly to the simultaneous instruction (prompt) received from the CPU.

A mechanism for generating commands: The mechanism for generating commands uses the AI model to generate commands from the analysis of the images. The commands can be simple, such as “open the door” or “turn off the machine,” or they can be more complex, such as “follow the closest object” or “identify the product on the shelf.”

A mechanism for sending the commands: The mechanism for sending the commands sends the commands to the devices. The commands can be sent directly to the devices or transmitted to a human user.

The system operates as follows:
The camera captures images of the environment.
The images are sent to the mini-CPU.
The mini-CPU processes the images and identifies objects and events.
The processed images along with the instruction or question (prompt) are sent to the cloud server.
The cloud server uses AI to understand the images and generate a response (reply).
The replies are sent to the mechanism for sending the commands.
The mechanism for sending the commands sends the commands to the devices.

1. Autonomous Camera Image Capture and Analysis System: A system comprising a camera and a mini-CPU, configured to operate autonomously for capturing images of the environment at predetermined intervals, in response to specific events or trigged by sensors, wherein captured images are transmitted, along with natural language prompts, to the Google Cloud AI platform (or another similar one available) through various network modalities, including cable, wireless, or mobile networks; further comprising a cloud server configured to analyze images utilizing artificial intelligence, interpreting them based on concurrent instructions (prompts) received from the mini-CPU and sending back a comprehensive response of the prompt for further actions by the system.

2. Intelligent Device Activation: The system of claim 1, wherein the processed images by the AI empower the system to activate external devices through relay outputs, issuing alerts across diverse communication channels, and providing responsive communication to the user.

3. Simplified Configuration and Parameterization: The system of claim 1, offering a configuration and parameterization in an existing human interface or through a dedicated app accessible via mobile or computer devices, utilizing Bluetooth, Wi-Fi, or cable connections, and enabling remote configuration and monitoring through network connections, whether via mobile networks or local Wi-Fi.

4. Comprehensive Environmental Monitoring: The system of claim 1, wherein a method for comprehensive environmental monitoring, comprising capturing images, processing images utilizing clouded AI, generating commands based on image analysis, and executing said commands to trigger external devices and communicate alerts and reports.

5. Enhanced Security Applications: The method of claim 4, wherein the system is applied for security or safety purposes, reducing false alarms or incorrect lack of that (false positives and negatives) through intelligent processing compared to traditional sensors.

6. Diverse Sectors Applications: The method of claim 4, further extending to unlimited residentials, personal, scientific, commercials or industrial sectors, including but not limited to environmental monitoring, scientific research, safety applications, or industrial process control, for instance.

7. Cost-Effective Camera Integration: The system of claim 1, wherein the camera integration is cost-effective, especially when compared to systems that aim to analyze images with onboard electronics or even connected to a dedicated local or remote server that intends to analyze the received images, ensuring accessibility and widespread adoption.

8. Dynamic Command Generation: The system of claim 1, wherein a mechanism for generating commands, utilizing AI models to generate commands from the analysis of images, ranging from simple actions to more complex tasks, such as device control or environmental identification.

9. Efficient Command Transmission: The system of claim 1, wherein a mechanism for sending commands, configured to efficiently send generated commands directly to devices or transmit them to a human user, enhancing overall system responsiveness.

10. Configuration: The system of claim 1, wherein a mechanism that can be easily configured through the existing man-machine interface on the device itself (for models equipped with this feature) or through a mobile app connected via Bluetooth, cable, or remotely. In the latter case, configuration can be done not only through the mobile app but also through a computer application.

11. Modes of Use: The system of claim 1, wherein a mechanism especially designed for stand-alone use, but that can be integrated into an internal TV circuit system or a remote administration system for a network of cameras that can centrally manage the configuration of each camera and receive alerts and reports.

12. Sensing: The system of claim 1, which may have integrated supplementary sensors within the camera itself, such as passive infrared sensors, thermal sensors, or Laser sensors, for example. Additionally, it will have one or more inputs to receive signals from external sensors that will trigger eventual actions, such as taking a photo with subsequent transmission to AI.

13. External Configuration and Parameterization: The system of claim 1, wherein it can be the configurated and parameterized by a desktop software or mobile App to perform, which will offer multiple alternatives, including inputs for free configuration in natural language and other complementary information fields such as phone numbers or email addresses for forwarding alerts, messages, and reports. Additionally, fields for checkmark-type selections that may contain various pre-defined commands and parameters.

14. Preprocessing: The system of claim 1, wherein it can optionally preprocess the image (compress, manipulate, interpret, compare, transform, save locally or remotely, etc.), as well as directly send SMS messages or emails or with the assistance of a remote server, containing single txt messages or reports.
